(19) United States
(12) Patent Application Publication
(10) Pub. No.: US 2025/0148726 A1
(43) Pub. Date: May 8, 2025

(54) DYNAMIC CREATION AND MANAGEMENT OF SPATIAL ANCHORS

(71) Applicant: Nokia Technologies Oy, Espoo (FI)

(72) Inventors: Jos GEORGE, Bangalore (IN); Laurent GOIX, Massy (FR); Saurabh KHARE, Bangalore (IN)

(21) Appl. No.: 18/937,935

(22) Filed: Nov. 5, 2024

(30) Foreign Application Priority Data
Nov. 6, 2023 (IN) 202341075802

(51) Int. Cl. G06T 19/00

(52) U.S. Cl. CPC G06T 19/006

(57) ABSTRACT

This application describes systems, apparatus and methods for the dynamic creation and management of spatial anchors. According to a first aspect of this specification, there is described apparatus comprising: means for receiving, from a service provider, a request to initiate a spatial anchor associated with a mobile object; means for generating the spatial anchor associated with the mobile object based on the received request; means for receiving, from the service provider or a user equipment, a request for retrieval of the spatial anchor associated with the mobile object; means for retrieving a location of the mobile object; means for updating the spatial anchor with the retrieved location of the mobile object; and means for providing, to the service provider or the user equipment, the updated spatial anchor.

### FIELD

This application describes systems, apparatus and methods for the dynamic creation and management of spatial anchors.

### BACKGROUND

A spatial anchor is an association between a location in space (e.g., three dimensions) and service information that can be used to identify and access services, for example, information to access augmented reality (AR) media content. Service information can include information to enable users to discover and access services, e.g. type of service, URLs, configuration data, the distance between the user and the spatial anchor, etc.

In the context of mobile metaverse services (including mobile AR), 3GPP TR 22.856 has further defined the concept of digital asset, as “digitally stored information that is uniquely identifiable and can be used to realize value according to their licensing conditions and applicable regulations. Examples of digital assets include digital image (avatar), software licenses, gift certificates and files (e.g. music files) that have been purchased under a license that allows resale.” In addition, a set of requirements have been defined to manage digital assets, possibly via a Digital Asset Container within the 5GC.

### SUMMARY

According to a first aspect of this specification, there is described apparatus comprising: means for receiving, from a service provider, a request to initiate a spatial anchor associated with a mobile object; means for generating the spatial anchor associated with the mobile object based on the received request; means for receiving, from the service provider or a user equipment, a request for retrieval of the spatial anchor associated with the mobile object; means for retrieving a location of the mobile object; means for updating the spatial anchor with the retrieved location of the mobile object; and means for providing, to the service provider or the user equipment, the updated spatial anchor.

The means for generating the spatial anchor associated with the mobile object may comprise: means for generating a digital asset representative of the spatial anchor, the digital asset comprising one or more spatial anchor properties; and means for storing the digital asset in a Digital Asset Container.

The one or more spatial anchor properties may comprise: a spatial anchor ID uniquely identifying the object; service information identifying one or more services associated with the spatial anchor; and a spatial location. The service information may comprise one or more of: a service description; a service URL; media content information; and/or configuration data for the service.

The method may further comprise: means for receiving, from the service provider, an update request for the spatial anchor; and means for updating one or more of the one or more properties of the spatial anchor based on the update request. The update request for the spatial anchor may comprise an identifier of the user equipment from which the request originated.

The one or more spatial anchor properties may comprise one or more timestamps, the one or more timestamps indicating: a spatial anchor creation time; a spatial anchor property update time; and/or a spatial anchor location update time.

The one or more spatial anchor properties may comprises location of one or more restricted zones. The apparatus may further comprise: means for determining, based on the location of the mobile object, whether the mobile object is within a restricted zone; and means for updating, in response to determining that the mobile object is within a restricted zone, the spatial anchor with a warning indication. The apparatus may further comprise: means for triggering one or more actions in dependence on the warning indication.

The apparatus may further comprise: means for restricting and/or preventing access to the spatial anchor based at least in part on an identity of the service provider or the user equipment.

According to a further aspect of this specification, there is described apparatus comprising: means for requesting, from a network, initiation of a spatial anchor associated with a mobile object; means for receiving, from a user equipment, a request for a service utilising the object as a spatial anchor; means for requesting the network to update one or more properties of the spatial anchor based on the request for the service; means for receiving, from the network, an updated spatial anchor; and means for causing transmission of the updated spatial anchor to the user equipment.

The updated spatial anchor may comprise a current location of the mobile object.

The updated spatial anchor may comprise a waring message indicating that a current location of the mobile object is within a restricted area.

According to a further aspect of this specification, there is described a computer implemented method comprising: receiving, from a service provider, a request to initiate a spatial anchor associated with a mobile object; generating the spatial anchor associated with the mobile object based on the received request; receiving, from the service provider or a user equipment, a request for retrieval of the spatial anchor associated with the mobile object; retrieving a location of the mobile object; updating the spatial anchor with the retrieved location of the mobile object; and providing, to the service provider or the user equipment, the updated spatial anchor.

According to a further aspect of this specification, there is described a computer implemented method comprising: requesting, from a network, initiation of a spatial anchor associated with a mobile object; receiving, from a user equipment, a request for a service utilising the object; requesting the network to update one or more properties of the spatial anchor based on the request for the service; receiving, from the network, the spatial anchor; and causing transmission of the spatial anchor to the user equipment.

### BRIEF DESCRIPTION OF THE DRAWINGS

Example embodiments will now be described by way of non-limiting example, with reference to the accompanying drawings, in which:

FIG. 1 shows a schematic overview of a system for providing a service to UE based on mobile spatial anchors;

FIG. 2 shows an example of a signalling diagram of a method for providing a service based on mobile spatial anchors;

FIG. 3 shows an example of a signalling diagram of a method for providing a service based on mobile spatial anchors in the presence of restricted zones;

FIG. 4 shows a flow diagram of an example method for dynamically creating and/or managing mobile spatial anchors;

FIG. 5 shows a flow diagram of an example method for providing a service based on mobile spatial anchors;

FIG. 6 shows an apparatus/system according to some example embodiments, which may form at least a part of a user equipment or network node; and

FIG. 7 shows a non-transitory medium according to some embodiments.

### DETAILED DESCRIPTION

Currently, spatial anchors are typically static, being tied to specific locations (e.g., exact or identified by some restricted 3d zone in space) and service information, which are made available by supplier to consumers via a mobile service provider, e.g., a metaverse provider. The use of moving spatial anchors, i.e., whose position may change over time, provide additional challenges that need to be solved.

As an example, moving spatial anchors could be associated to real objects, whose locations could be derived and tracked by relying on a Location Management Function (LMF), e.g., a 3GPP LMF. Alternatively or additionally, additional characteristics could be attached to moving spatial anchors as “filters”, in order to track them more accurately within a certain 3d space, e.g., via computer vision based on pre-identified objects (e.g., based on markers, pictures or 3D models/shapes).

Another challenge lies in managing moving spatial anchors (e.g., connected cars, or other objects) as they traverse restricted areas (e.g., “entering prohibited zones”), requiring dynamic updates to their locations and service information to be compared against specific areas for regulatory compliance, safety, and real-time service accuracy.

Moreover, ensuring the authenticity of these anchors, along with other service information, such as associated objects or shapes (e.g., connected cars or devices), is an important consideration.

To meet these demands, a wireless network operator (e.g., a 5G operator) operating at least a part of a core network (e.g., 5GC), can take ownership and administration of the spatial anchor system, facilitating the management of dynamic spatial anchors for content producers, customers, and metaverse service providers. The core network provides spatial anchors as a service, in which the core network exposes APIs to request spatial anchor or manage or create spatial anchor at the core network. Managing the security and privacy of the spatial anchors and the involved users is handled by the core network. The core network also handles spatial anchor movement with respect to restricted zones. However, the content of a spatial anchor is defined in application data provided by a third-party service provider, e.g., a metaverse service provider.

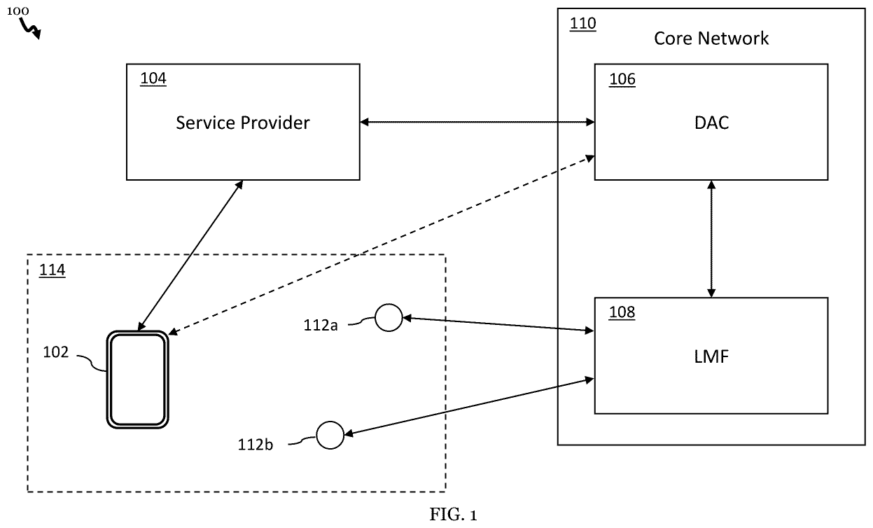

FIG. 1 shows a schematic overview of a system 100 for providing a service to UE 102 based on mobile spatial anchors. The system comprises a UE 102 in a spatial area 114 (also referred to herein as an “environment”) containing one or more mobile objects 112a, 112b that are utilised as spatial anchors for a service provided by a service provider 104, e.g., a metaverse service provider. The spatial anchors associated with the mobile objects 112a, 112b are managed by a core network 110 (e.g., a 5GC network), which stores and manages each spatial anchor as a digital asset in a Digital Asset Container 106 (DAC), and retrieves location data for the mobile objects using a Location Management Function 108 (LMF), e.g., a 3GPP LMF.

The UE 102 may be any device that a user can use to communicate wirelessly with a network, e.g., the core network 110 or a network of the service provider 104. Examples of such UEs 102 include, but are not limited to, smartphones, tablets, smart glasses, or the like. The UE 102 may execute one or more applications that provide access to one or more services that are operated/managed by the service provider 104 and which utilize spatial anchors associated with the mobile objects 112a, 112b. For example, the service provider 104 may be a metaverse service provider, providing augmented reality (AR) content to a user via an application on the UE 102.

The mobile objects 112a, 112b are, in some examples, networked devices, e.g., further UEs, IoT devices or the like. Such networked devices may communicate with the core network 110 wirelessly. The LMF 106 of the core network 110 may determine the locations of the networked devices directly, using any wireless location techniques known in the art.

In some examples, the mobile objects 112a, 112b are not networked objects, e.g., objects in a store, or objects in an environment. In such examples, the location of the mobile objects 112a, 112b may be determined indirectly, e.g., using computer vision capabilities of the UE 102. For example, additional characteristics could be attached to the digital asset representing the mobile objects 112a, 112b that act as “filters” in order to track them more accurately within a certain 3D space, e.g., via computer vision based on a pre-identified objects (e.g., marker, picture or 3D model/shape).

Utilizing the DAC 106 as a spatial anchor repository ensures secure and efficient management of the spatial anchor lifecycle through a DAC authorization service. The DAC 106 receive real-time updates from the service provider 104 (or other systems managed by the owner) to ensure it has the latest and most accurate spatial anchor service information.

When a user engages in a service that utilizes spatial anchors, e.g., an augmented reality (AR) service, the UE 102 of the user and/or the service provider 104 providing the service requests the DAC 106 for spatial anchors within a certain location space. This involves the retrieval of spatial anchors associated to a mobile object 112a, 112b by the DAC 106, during which the DAC 106 may automatically fetch the current physical location of the mobile object 112a, 112b via the LMF 108. The DAC 106 then dynamically generates spatial anchors by combining real-time location information of the mobile objects 112a, 112b with relevant service information, ensuring accuracy and efficiency in the process. Alternatively, the DAC 106 can offer quick access to spatial anchor locations based on previously retrieved locations without real-time location lookups, ensuring data accuracy and reliability through regular database updates.

In some examples, the DAC 106 provides spatial anchors with service information including optional privacy filters (e.g., to authorized users only), within the spatial anchor metadata provided by various stakeholders, such as metaverse service providers, operator, and content providers or the like. The DAC 106 may also implement a privacy and consent framework for collecting new kinds of data (e.g., camera data, sensor data etc), i.e., the core network 110 shall not collect this data without a new consent agreed with user. Consent can, in some examples, be on a per spatial anchor level as well.

In some implementations, the 5G operator and/or service provider 104 provides the DAC 106 with the locations of restricted zones, and the DAC 106 checks if the mobile object 112a, 112b location falls within any of these restricted areas. If so, the DAC 106 can generate a spatial anchor with a warning message, indicating the presence of the mobile object 112a, 112b in a restricted zone. This warning message can trigger appropriate actions to ensure compliance, safety, and data privacy in sensitive areas. In other scenarios, the DAC 106 will refrain from providing a spatial anchor to a user due to security concerns, for example when encountering fake spatial anchors (e.g., uncertified, or provided by a supplier who is not accountable for that location). In some implementations, the DAC 106 can send warning messages and error logs to an Operation and Maintenance (O&M) system of a 5G network. This information can allow the O&M system to improve its capabilities and take proactive measures to prevent the creation of fake spatial anchors in the future.

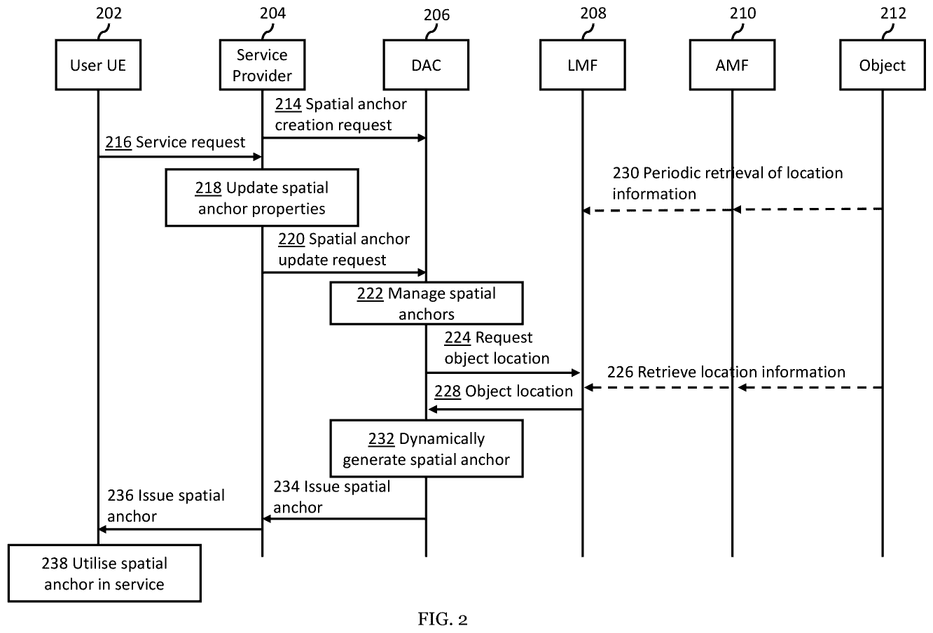

FIG. 2 shows an example of a signalling diagram of a method for providing a service based on mobile spatial anchors. The example will be described with respect to an AR service guiding a user to a rental car, though other examples (both AR-based and non-AR-based) are also possible. The method may be performed by the system of FIG. 1.

Prior to the use of an object 212 as a spatial anchor by a UE 202, a service provider 204 associated with the object 212 submits a request 214 to the core network for creation of spatial anchor. The request 214 to create the spatial anchor is, in some examples, a one-time process for each object 212.

The request 214 comprises information about the object sufficient to enable the spatial anchor to be initiated. For example, the request 214 may comprise one or more of: an identifier for the requesting entity, i.e., the service provider 204; an anchor ID, e.g., a numerical or alphanumerical identifier for the spatial anchor; an anchor entity, identifying the object 212; a 3D model and/or picture of the object 212 for use in computer vision recognition of the object 212; and/or one or more asset details, indicating properties of the object 212. In some examples, a current location of the object 212 is also included. Alternatively, a request for the core network to retrieve the current location of the object 212 using a location management function 208 may be included.

In some examples, the core network collects location information of networked devices (e.g., 3GPP devices) with prior consent of the device owners.

For the example of a rental car, an example request may be:

```
{
“request type”: “spatial_anchor_create”,
“requesting_entity”: “metaverse_service_provider”,
“anchor_id”: “54321”,
“anchor_entity”:
      “connected_car_id”: “IMSI1”
},
“asset_details”: {
      “type”: “rent_a_car”,
      “car_make”: “Volvo”,
      “car_model”: “XUV”
      “availability”: “available”
},
“location information”: {
      “lattitude”: 37.7749
      “longitude”: −122.4194
      “altitude”: 50.0
}
}
```

The core network sets up and stores the spatial anchor as a digital asset in a Digital Asset Container 206 (DAC). The digital asset representing the spatial anchor comprises: a spatial location; service information; and a spatial anchor ID.

The spatial location comprises at least one valid location in three-dimensional space. It may comprise reference coordinates, e.g., (X, Y, Z). This information can help accurately position and align virtual content or services in relation to the real-world environment. In some examples, it can be used to filter spatial anchors with respect to a consumer/UE location. Note that whilst this location information is provided to the consumer/UE, it may not be provided/known by the service provider itself, which rather could provide either a 3GPP unique identifier of the associated UE (to be tracked by the core network), or some related information that can allow the core network to indirectly retrieve this identifier (e.g. via a catalogue/database).

The spatial anchor can include relevant service information that enables the identification and access of associated services. This can, for example, include details such as: the type of service; service description; URLs and/or endpoints to access the service; media content information (e.g., AR media); and/or configuration data required to utilize the service.

Each spatial anchor can be assigned a unique identifier or ID, which serves as a reference for easy identification and retrieval. The ID can be used to uniquely associate the spatial anchor with its corresponding service information.

In some examples, the digital asset further comprises one or more timestamps/time information indicating, for example: a time/date the spatial anchor was created and/or last modified; and/or a time/date that the spatial anchor position was last updated.

In some examples, the digital asset further comprises additional metadata, such as creator information, versioning details, privacy settings and/or any other relevant attributes that provide further context or management capabilities for the spatial anchor.

Once the spatial anchor has been set up as a digital asset, it is available for use in services provided by the third-party service provider. A UE 202 (also referred to herein as a “user UE”) subsequently requests 216 a service from the service provider 204, e.g., initiates an AR experience with a rent-a-car service provider and sends a car rental request to the metaverse of the service provider 204. The request 214 may comprise a selection of a particular service, e.g., a choice of car from a set of available rental cars.

Once the user finalizes the service selection, via their device 202 or otherwise, the service provider 204 proceeds to update 218 properties of the spatial anchor(s) for the mobile object(s) associated with the service locally, granting authorization to the user to utilize the spatial anchors, thereby enabling them to access the service. For example, once the user 202 finalizes a car rental process selecting a car (i.e., the mobile object 212), the car rental company (i.e., the service provider 204) proceeds to update 218 the spatial anchor associated to a specific car of that category, granting authorization to the user, thereby enabling them to view and access the selected car in AR.

Following the local update 218 of the spatial anchor properties, the service provider 204 initiates an updated spatial anchor creation request 220, by either providing metadata for the DAC 206 to retrieve the identity of each mobile object 212 (e.g., to retrieve the IMSI1 of a rental car) or directly including the identity of mobile object 212 (e.g., the IMSI1 of a car). Additionally, the request may contain an identifier of the user 202 requesting the service (e.g., in the case of the rental car, an IMSI2).

As an illustrative example, an example update request 220 for a user 202 to be associated with a rental car may be given by:

```
{
  “request_type”: “spatial_anchor_update”,
  “requesting_entity”: “renting_user”,
  “anchor_id”: “54321”,
  “anchor_entity”: {
    “connected_car_id”: “IMSI1”
  },
  “renting_user_id”: “IMSI2”,
  “asset_details”: {
    “type”: “rent_a_car”,
    “car_Make”: “Volvo”,
    “car_Model”: “XUV”,
    “availability”: “available”
    }
}
```

While the update request is being processed, the user UE 202 may initiate the service, for example start a mobile AR experience at their location (not shown).

In some examples, when a user 202 starts the service, e.g., a mobile AR experience to find a car, the core network may request an OTP or token from the user (not shown) to verify the presence of the user at a location associated with the service and/or the requested spatial anchors. The token or OTP may, in some examples, only be accessible from that location (e.g. based on a visual display, QR code etc.). Additionally, this security mechanism could be associated with metadata about the request, e.g. with preconfigured anchor types/IDs, helping to further refine the search process.

The DAC 206 manages 222 service information related to the requested service (e.g., rental car) within its asset list. For example, the DAC 206 updates the spatial anchor based on the update request 220 from the service provider 204. When an object identifier for the mobile object (e.g., IMSI1) is not provided in the request, DAC 206 can fetch an identifier of a connected mobile object, matching it with properties provided in the update request 220, e.g., the “asset_details” mentioned in the request.

In some examples, managing 222 service information related to the requested service comprises verifying permission for location information collection of the mobile object by checking a consent flag stored in the unified data management (UDM) system of the core network. This flag ensures that the core network collects location data, sensor, and/or camera information for spatial anchor creation only with the prior consent of device owners, aligning with user privacy preferences.

In some examples, managing 222 service information related to the requested service comprises, in the case of already created spatial anchors, retrieving a list of spatial anchors based on the requested anchor type and/or ID. Managing 222 service information may further comprise examining current location(s) of the mobile object(s), and ensuring they fall within a specific range of locations. The range of locations may comprise a range defined by the service provider 204, such as one or more physical locations associated with the service provider, e.g., a shop location, a factory location, a warehouse location, an event location or the like.

The DAC 206 may further verify the authenticity and certification of the spatial anchors, taking into consideration whether they were provided by authorized providers in the respective location.

In some examples, the DAC 206 prioritizes user identity and leverages Role-Based Access Control (RBAC) to enforce user-specific permissions. This RBAC mechanism determines the rights of the requesting user 202, allowing them to access and view relevant service information when they are authorized to do so.

To determine a location of a mobile object, the DAC 206, in some examples, requests 224 a Location Management Function (LMF) to retrieve a current location of the mobile object 212. In some examples, this triggers the LMF 208 to retrieve 226 the current location of the mobile object, e.g., using any LMF-based location method known in the art, and provide the mobile object location 228 to the service provider 204.

Alternatively, in some examples, the LMF 208 periodically retrieves 330 the location of the mobile object 212, and stores it, providing it to the service provider 204 upon request 224, i.e., the DAC 206 subscribes to the mobile object location for regular updates on position changes. Such implementations can enable the DAC 206 to provide quick access to spatial anchor locations without relying on real-time location lookups. This approach can be used in scenarios where real-time location information is not critical or may not be feasible. Additionally, DAC ensures data accuracy and reliability by regularly updating the spatial anchor locations in its database, providing users with the most current and relevant information.

The option to enable quick access to spatial anchor locations without relying on real-time location lookups can be achieved through preloading/caching spatial anchor data in the DAC 206. The DAC regularly updates its database with the latest spatial anchor information. These updates can be scheduled at specific intervals or triggered based on certain events, such as changes in the environment or service information associated with spatial anchors.

In an illustration, the location information received from the mobile object 212 may be provided as latitude and longitude values, will undergo a geospatial transformation. This process will convert the data into precise three-dimensional coordinates (X, Y, Z) to accurately represent the mobile object position and orientation within the spatial anchor.

The specific method used to obtain location information may vary, e.g., based on the device capabilities of the mobile object 212, the application requirements for the service, and/or the level of accuracy needed for the particular use case. The mobile object 212 sends location information to an Access and Mobility Management Function 210 (AMF) through control plane signaling, and the AMF 210 can relay this information to the LMF 208. The LMF 208 can then process this location information and use it for various purposes, such as spatial anchor management, AR communication, or asset tracking, depending on the application functionality.

Once the current locations 228 of the mobile object 212 have been retrieved, the DAC 206 dynamically generates/updates spatial anchors by combining location information and service information. The core network/DAC 206 can, in some examples, use sensing data, AI, machine-learning and/or network data analytics function analytics (e.g., a 5G NWDAF) to generate a spatial anchor.

By combining location information and service information, the DAC 206 can effectively associate the provided services with corresponding physical locations, facilitating seamless access to augmented reality (AR) content and services. The DAC 206 may, in some examples, add privacy filters to spatial anchors, limiting the visibility of certain spatial anchors to specific users and/or user groups. This can enhance data privacy and give better control over who can access the service information. In other words, spatial anchors can be selectively shared based on user permissions, operator policy and/or other predefined criteria. This ensures that only authorized users and/or designated groups have access to certain AR content or services, safeguarding sensitive or restricted information.

The DAC 206 offers precise spatial anchors with comprehensive service information, for example, optional filters like 3D models and car pictures. Privacy filters are provided to restrict access to specific users or groups, enhancing data privacy. These settings are sent as configuration data within the spatial anchor metadata when the DAC 206 issues 234 the spatial anchor to the service provider 204, allowing the service provider 204 to implement and share 236 spatial anchors with users 202.

Once issued 236 with one or more spatial anchors used in the service, the user UE 202 utilizes the spatial anchors in providing the service to the user. For example, the user 202 is guided to the rental car they have rented by the spatial anchor.

As a further example of the significance of dynamic spatial anchors in a real-world context, consider the use of spatial anchors in providing a service in a cheese shop. For the concept to thrive in real-world applications, it is useful that spatial anchors remain dynamic rather than static. This flexibility allows a shop holder to freely rearrange pieces of cheese (symbolizing brand logos and/or packaging) in a physical store location, while preserving the association with their respective service information. To achieve this, a shop holder captures an image of each piece of cheese (e.g., the packaging and/or brand logo), creating a unique “filter” that is linked to the corresponding spatial anchor. All spatial anchors, representing pieces of cheese, are tied to the 3D space of the shop as their location.

When a user/consumer enters the shop, they are granted virtual access to observe all recognized pieces of cheese, precisely positioned in the shop based on their User Equipment (UE) computer vision capabilities. The UE may actively scan for the various picture filters when in the application used by the shop. This allows seamless tracking if any piece of cheese is moved over time. Only spatial anchors from that specific shop holder are visible in the shop, ensuring a personalized and relevant consumer experience.

This example underscores the vital role of dynamic spatial anchors in effectively associating location and service information. Through computer vision technology, consumers can virtually explore and interact with the content, creating a truly immersive and engaging experience.

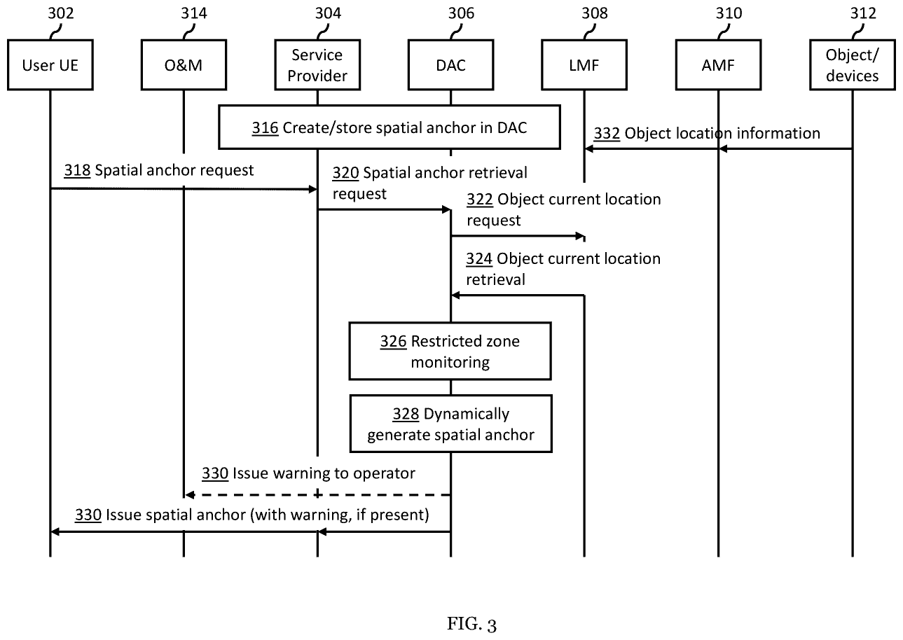

FIG. 3 shows an example of a signalling diagram of a method for providing a service based on mobile spatial anchors in the presence of restricted zones. The call flow is described in relation to a practical use case of a user remotely managing one or more devices, e.g., a robot owner remotely managing a robot via its digital twin representation in a factory-owned metaverse service. However, it will be appreciated that other use cases are possible.

The service provider 304 creates and stores 316 spatial anchors in the DAC 306, securely updating or creating service information as required, as described in relation to FIG. 2. It retrieves and shares spatial anchors with users as needed, as described in relation to FIG. 2. The authenticity of service information for the spatial anchor can, in some examples, be ensured by restricting permissions to modify the spatial anchor's service information to only the asset owner (e.g., the service provider 304, a sub-organisation of the service provider, or some other third party) through the implementation of Role-Based Access Control (RBAC) issued by DAC 306. The DAC 306 can receive real-time updates from the service provider 304 or other systems managed by the owner to ensure it has the latest and most accurate service information.

Once the spatial anchor is created, the object/device 312 associated with the spatial anchor may periodically provide location updates 332 to the LMF 306 via the AMF 310, as described in relation to FIG. 2.

Subsequent to the spatial anchor creation, a user may remotely manage one or more devices via a user UE 302, and request 318 spatial anchors from the service provider 304 to effectively manage and interact with the one or more devices 312. Examples of such a request are described in further detail in relation to FIG. 2. In response, the service provider 304 initiates a spatial anchor retrieval request 320 to the DAC 306 for obtaining the required spatial anchor, as described in further detail in relation to FIG. 2. Upon receiving the request 320 from the service provider 304, the DAC 306 requests 322 the current location of the device 312 from the LMF 308, which returns 322 the current object location in response. Examples of such a location retrieval are described in further detail in relation to FIG. 2.

The DAC monitors 326 the current location of the device 312 with respect to the locations of one or more restricted zones. The operator 314 provides the DAC 106 with the locations of restricted zones, which are areas where the device's presence is restricted or disallowed. The DAC 106 then checks the received location 324 of the device 312 to determine if it falls within any of these restricted zones.

If the device 312 is found to be within a restricted zone, the DAC 106 generates 328 a spatial anchor with service information as normal, i.e., as described in relation to FIG. 2.

If the device 312 is found to be within a restricted zone, the DAC 106 generates 328 a spatial anchor with service information that comprises a warning message. This warning message indicates that the device 312 is currently present in a restricted zone. The warning may trigger appropriate actions, such as notifying the user, stopping operations, or issuing warnings 330 to the relevant authorities or stakeholders. This mechanism helps ensure compliance with regulations, safety measures, and data privacy requirements in sensitive or restricted areas.

In some examples, the DAC 106 will refrain from providing a spatial anchor to a user due to security concerns, particularly when encountering fake spatial anchors.

To detect fake spatial anchors, the DAC 106 can employ data consistency checks and verification methods e.g., cross-referencing location data with reliable historical values and operator-maintained sources. If discrepancies arise, the DAC 106 can withhold the spatial anchor to prevent dissemination of misleading or inaccurate information.

Furthermore, the DAC 106 may ensure the authenticity of service information associated with spatial anchors. By scrutinizing service-related elements like URIs, endpoint details, and 3D models, the DAC 106 can prevent sharing spatial anchors containing fake or malicious content with users. By implementing these security measures, the DAC 106 safeguards the integrity and reliability of the spatial anchor system, promoting trustworthy and accurate location-based services within the 5G network environment.

In some implementations, the DAC 106 can transmit warning messages and error logs to the 5G network's Operation and Maintenance 314 (O&M) system. The O&M system 314 can leverage this valuable information to enhance its capabilities, enabling proactive measures to prevent the creation of fake spatial anchors in the future.

The DAC 106 delivers 330 the spatial anchor with service information to the user UE 302, via the service provider 304. If the device 312 associated with a spatial anchor is in a restricted zone, the service information comprises a warning message indicating a “restricted zone,” to the user. Alternatively, e.g., if the spatial anchor was fake, the response 330 from DAC 106 may not contain that spatial anchor.

The spatial anchor information empowers the user to make informed decisions, enabling actions like redirecting the device or halting its operation as needed.

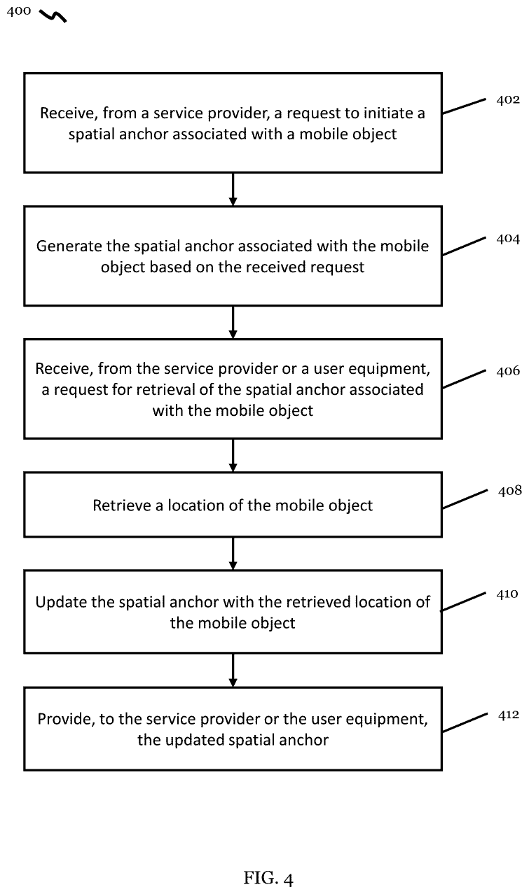

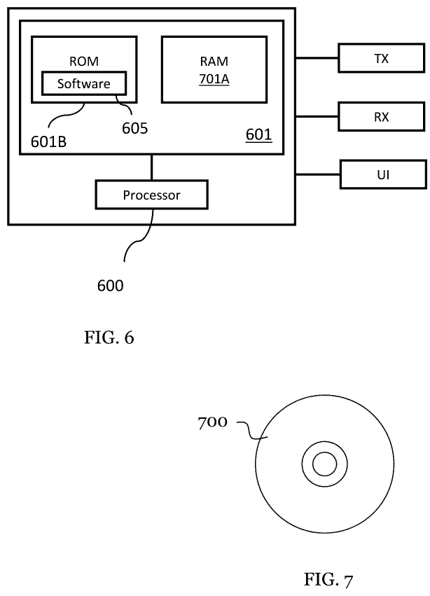

FIG. 4 shows a flow diagram of an example method for dynamically creating and/or managing mobile spatial anchors. The method may be performed by an apparatus/system comprising means for performing each of the operations of the method. For example, the method may be performed by the apparatus/system described in relation to FIG. 6. For convenience, the method is described as being performed by a system, e.g., a system forming a part of a core network.

At operation 402, the system receives, from a service provider, a request to initiate a spatial anchor associated with a mobile object. The mobile object is, in some examples, a networked device, e.g., a user equipment. In some examples, the mobile object is a non-networked object, e.g. a product.

The request may comprise service information to be associated with the mobile object, e.g., one or more properties of the mobile object; one or more properties of services associated with the mobile object; one or more properties of the service provider (e.g., an identifier, one or more locations etc.); a list of permissions for accessing the spatial anchor, etc.

At operation 404, the system generates the spatial anchor associated with the mobile object based on the received request. Generating the spatial anchor associated with the mobile object may comprise generating a digital asset representative of the spatial anchor. The digital asset may be stored in a Digital Asset Container (DAC).

The digital asset comprises one or more spatial anchor properties, for example, a spatial anchor ID uniquely identifying the object (e.g., a numerical or alphanumerical identifier), service information identifying one or more services associated with the spatial anchor, (e.g., the type of service, service description, URLs or endpoints to access the service, media content information, such as AR media, or configuration data required to utilize the service) and/or a spatial location (e.g., coordinates in a 3D reference frame, such as longitude, latitude and altitude, or cartesian coordinates with respect to some reference point/origin).

In some implementations, the one or more spatial anchor properties comprise one or more timestamps, the one or more timestamps indicating: a spatial anchor creation time; a spatial anchor property update time; and/or a spatial anchor location update time. In some implementations, the one or more spatial anchor properties comprise metadata comprising one or more of: creator information; versioning details; privacy settings; and/or any other relevant attributes that provide further context or management capabilities for the spatial anchor.

In some implementations, the system receives, from the service provider, an update request for the spatial anchor. The update request may be based on an identity of a user requesting the service, e.g., the update request may assign the spatial anchor to the user and/or indicate that the user has the right to use the spatial anchor. The update request may identify the user using a unique ID of the UE associated with the user. For example, in the case of a car rental, the update request may contain an identifier for the user assigned to a particular rental car. Alternatively or additionally, the update request may comprise updated values of one or more of the properties of the spatial anchor, a request to add one or more further properties to the spatial anchor, and/or a request to remove one or more properties from the spatial anchor.

In response to an update request, the system updates one or more of the one or more properties of the spatial anchor based on the update request, i.e., properties of the digital asset are updated and stored in the DAC.

At operation 406, the system receives, from the service provider or a user equipment, a request for retrieval of the spatial anchor associated with the mobile object. In examples where the request is received from the service provider, the request may have been triggered by a request to the service provider for a service from a UE. In some examples, the request for the for retrieval of the spatial anchor associated with the mobile object is, or is combined with, an update request for the spatial anchor, e.g., the update request itself also acts as the request for retrieval of the spatial anchor associated with the mobile object.

At operation 408, the system retrieves the location of the mobile object. The system may retrieve the location of the mobile object in response to the request for the spatial anchor. Alternatively, the system may retrieve the location of the mobile object periodically.

In some implementations, the system uses a network location management function to retrieve and/or monitor the location of the mobile object. The location management function may retrieve the location of the mobile object in response to a request from the DAC for the object location, i.e., obtain a current location of the object using any location technique known in the art. Alternatively, the LMF may receive location updates for the object periodically, or when one or more threshold conditions are satisfied (such as the object detecting it is or has moved), and provide the most recent location to the DAC upon request.

In some implementations, the one or more spatial anchor properties comprises locations of one or more restricted zones, i.e., zones in which the mobile object is not allowed to be located. In such implementations, the system compares the mobile object location to the locations of the one or more restricted zones in order to determine, whether the mobile object is within a restricted zone or not. In response to determining that the mobile object is within a restricted zone, the system updates the spatial anchor with a warning indication, e.g., service information that serves as a warning message. This warning message indicates that the device is currently present in a restricted zone, and may trigger one or more further actions, e.g., notifying the user, stopping operations of the mobile object/the user UE, and/or issuing warnings to the relevant authorities or stakeholders.

At operation 410, the system updates the spatial anchor with the retrieved location, i.e., dynamically generates an up-to-date spatial anchor. If the retrieved location is within a restricted area, the system updates the service information to include a warning.

At operation 412, the system provides, to the service provider or the user equipment, the updated spatial anchor. The service provider and/or the user equipment use the spatial anchor (and, in some examples, one or more further spatial anchors), to provide a service to the user, e.g., an augmented reality service.

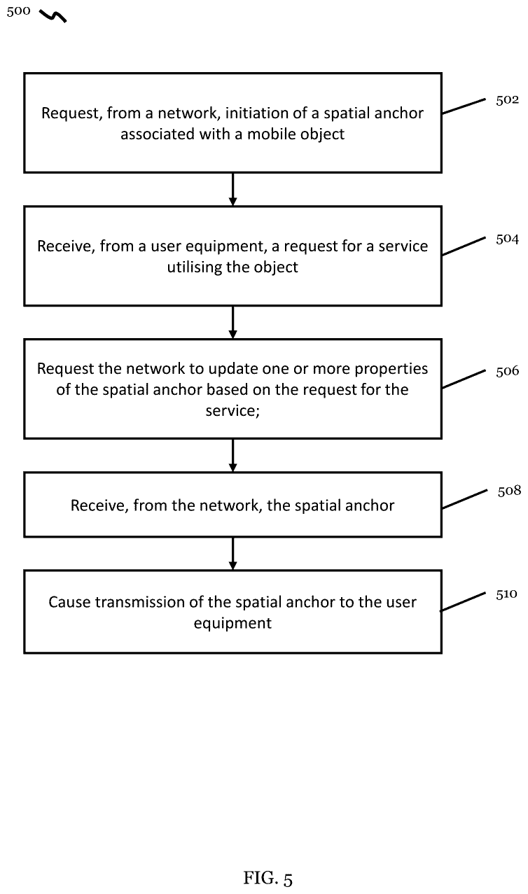

FIG. 5 shows a flow diagram of an example method for providing a service based on mobile spatial anchors. The method may be performed by an apparatus/system comprising means for performing each of the operations of the method. For example, the method may be performed by the apparatus/system described in relation to FIG. 6. For convenience, the method is described as being performed by a system, e.g., a system of a service provider.

At operation 502, the system requests, from a network, initiation of a spatial anchor associated with a mobile object. The request may comprise service information to be associated with the mobile object, e.g., one or more properties of the mobile object; one or more properties of services associated with the mobile object; one or more properties of the service provider (e.g., an identifier, one or more locations etc.); a list of permissions for accessing the spatial anchor, etc.

At operation 504, the system receives, from a user equipment, a request for a service utilising the object as a spatial anchor. The request may originate from an application running on the user equipment that is associated with the service provider. The application may be an augmented reality application.

At operation 506, the system requests the network update one or more properties of the spatial anchor based on the received request for the service. The update request may, for example, comprise a request to associate the requesting user equipment with the spatial anchor.

The update request may further act as a request for the spatial anchor from the network (e.g., from a DAC of the core network). Alternatively, the update request may be accompanied by an explicit request for the spatial anchor.

At operation 508, the system receives, from the network, an updated spatial anchor. The spatial anchor may be updated with the current location of the mobile object. In some examples, if the object is determined by the network to be in a restricted area, the service information of the updated spatial anchor may comprise a warning that the object is in a restricted area.

At operation 510, the system causes transmission of the updated spatial anchor to the user equipment. The user equipment use the spatial anchor (and, in some examples, one or more further spatial anchors), to provide a service to the user, e.g., an augmented reality service.

FIG. 6 shows an apparatus/system according to some example embodiments, which may form at least a part of a user equipment or network node. The apparatus may be configured to perform the operations described herein, for example operations described with reference to any disclosed process. The apparatus comprises at least one processor 600 and at least one memory 601 directly or closely connected to the processor. The memory 601 includes at least one random access memory (RAM) 601A and at least one read-only memory (ROM) 601B. Computer program code (software) 605 is stored in the ROM 601B. The apparatus may be connected to a transmitter (TX) and a receiver (RX). The apparatus may, optionally, be connected with a user interface (UI) for instructing the apparatus and/or for outputting data. The at least one processor 500, with the at least one memory 601 and the computer program code 605 are arranged to cause the apparatus to at least perform at least the method, or a part of the method, according to any preceding process, for example as disclosed in relation to the signalling diagrams of FIGS. 2 and/or 3, and/or the flow diagram of FIGS. 4 and/or 5, and related features thereof.

FIG. 7 shows a non-transitory media 700 according to some embodiments. The non-transitory media 700 is a computer readable storage medium. It may be e.g., a CD, a DVD, a USB stick, a blue ray disk, etc. The non-transitory media 700 stores computer program code, causing an apparatus to perform the method of any preceding process for example as disclosed in relation to the flow diagrams and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as Wi-Fi.

A memory may be volatile or non-volatile. It may be e.g., a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above-described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

We claim:

1. An apparatus comprising:
at least one processor; and
at least one memory storing instructions which, when executed by the at least one processor, cause the apparatus to perform:
receiving, from a service provider, a request to initiate a spatial anchor associated with a mobile object;
generating the spatial anchor associated with the mobile object based on the request to initiate;
receiving, from the service provider or a user equipment, a request for retrieval of the spatial anchor associated with the mobile object;
retrieving information identifying a location of the mobile object;
updating, after the retrieving, the spatial anchor with the information identifying the location of the mobile object; and
providing, after the updating, to the service provider or the user equipment, the spatial anchor.

2. The apparatus of claim 1, wherein the generating the spatial anchor associated with the mobile object comprises:
generating a digital asset representative of the spatial anchor, the digital asset comprising one or more spatial anchor properties; and
storing the digital asset in a Digital Asset Container.

3. The apparatus of claim 2, wherein the one or more spatial anchor properties comprise:
a spatial anchor ID uniquely identifying the mobile object;
service information identifying one or more services associated with the spatial anchor; and
spatial location information.

4. The apparatus of claim 3, wherein the service information comprises, for a service of the one or more services, one or more of the following:
a service description;
a service URL;
media content information; or
configuration data for the service.

5. The apparatus of claim 2, wherein the instructions, when executed by the at least one processor, cause the apparatus to perform:
receiving, from the service provider, an update request for the spatial anchor; and
updating one or more of the one or more properties of the spatial anchor based on the update request.

6. The apparatus of claim 5, wherein the update request for the spatial anchor comprises an identifier of the user equipment from which the update request originated.

7. The apparatus of claim 2, wherein the one or more spatial anchor properties comprise one or more timestamps, the one or more timestamps indicating one or more of the following:
a spatial anchor creation time;
a spatial anchor property update time; or
a spatial anchor location update time.

8. The apparatus of claim 2, wherein the one or more spatial anchor properties comprises information identifying locations of one or more restricted zones, and wherein the instructions, when executed by the at least one processor, cause the apparatus to perform:
determining, based on the location of the mobile object, whether the mobile object is within a restricted zone of the one or more restricted zones; and
updating, in response to determining that the mobile object is within the restricted zone, the spatial anchor with a warning indication.

9. The apparatus of claim 8, wherein the instructions, when executed by the at least one processor, cause the apparatus to perform:
triggering one or more actions in dependence on the warning indication.

10. The apparatus of claim 1, wherein the instructions, when executed by the at least one processor, cause the apparatus to perform:
preventing access to the spatial anchor based at least in part on an identity of the service provider or the user equipment.

11. The apparatus of claim 1, wherein the instructions, when executed by the at least one processor, cause the apparatus to perform:
restricting access to the spatial anchor based at least in part on an identity of the service provider or the user equipment.

12. An apparatus comprising:
at least one processor; and
at least one memory storing instructions which, when executed by the at least one processor, cause the apparatus to perform:
requesting, from a network, initiation of a spatial anchor associated with a mobile object;
receiving, from a user equipment, a request for a service utilising the object as a spatial anchor;
requesting the network to update one or more properties of the spatial anchor based on the request for the service;
receiving, from the network, an updated spatial anchor; and
causing transmission of the updated spatial anchor to the user equipment.

13. The apparatus of claim 12, wherein the updated spatial anchor comprises information identifying a current location of the mobile object.

14. The apparatus of claim 12, wherein the updated spatial anchor comprises a warning message indicating that a current location of the mobile object is within a restricted area.

15. A non-transitory computer-readable storage medium storing instructions that, when executed by an apparatus, cause the apparatus to perform:
receiving, from a service provider, a request to initiate a spatial anchor associated with a mobile object;
generating the spatial anchor associated with the mobile object based on the request to initiate;
receiving, from the service provider or a user equipment, a request for retrieval of the spatial anchor associated with the mobile object;
retrieving information identifying a location of the mobile object;
updating, after the retrieving, the spatial anchor with the information identifying the location of the mobile object; and
providing, after the updating, to the service provider or the user equipment, the spatial anchor.

16. The non-transitory computer-readable storage medium of claim 15, wherein the generating the spatial anchor associated with the mobile object comprises:
generating a digital asset representative of the spatial anchor, the digital asset comprising one or more spatial anchor properties; and
storing the digital asset in a Digital Asset Container.

17. The non-transitory computer-readable storage medium of claim 16, wherein the one or more spatial anchor properties comprise:
a spatial anchor ID uniquely identifying the mobile object;
service information identifying one or more services associated with the spatial anchor; and
spatial location information.

18. The non-transitory computer-readable storage medium of claim 17, wherein the service information comprises, for a service of the one or more services, one or more of the following:
a service description;
a service URL;
media content information; or
configuration data for the service.

19. The non-transitory computer-readable storage medium of claim 16, wherein the instructions, when executed by an apparatus for communication, cause the apparatus to perform:
receiving, from the service provider, an update request for the spatial anchor; and
updating one or more of the one or more properties of the spatial anchor based on the update request.

20. The non-transitory computer-readable storage medium of claim 19, wherein the update request for the spatial anchor comprises an identifier of the user equipment from which the update request originated.
